(19) United States
(12) Patent Application Publication
(10) Pub. No.: US 2014/0365233 A1
(43) Pub. Date: Dec. 11, 2014

(54) INTERACTIVE HEALTH MANAGEMENT SYSTEM AND METHOD

(71) Applicant: Metabolic and Cardiovascular Institute of Florida, LLC, West Palm Beach, FL (US)

(72) Inventors: Samuel Howard Sadow, West Palm Beach, FL (US); Jason Mankiewicz, West Palm Beach, FL (US)

(21) Appl. No.: 13/913,856

(22) Filed: Jun. 10, 2013

(51) Int. Cl. G06F 19/00

(52) U.S. Cl. CPC G06F 19/3418
USPC 705/2

(57) ABSTRACT

An online weight management system and maintenance program for the comprehensive medical treatment of obesity and obesity related illnesses. In an online environment, prospective patients are invited to register for the program, and, if approved, are presented with interactive sessions, where, under the supervision of an assigned physician or health coach, the patient receives medical advice and step-by-step medical guidance in order to achieve the patient's desired medical goals. Sessions are completed, results obtained, and interactive feedback is presented to the patient on a periodic basis.

### FIELD OF THE INVENTION

The present invention relates to weight management systems and more specifically to an automated and interactive physician supervised, online weight and health management and maintenance system for the comprehensive medical treatment of obesity and obesity related illnesses, that includes a HIPAA-compliant message board for physician, patient and administration interaction.

### BACKGROUND OF THE INVENTION

Obesity, particularly in the United States, has become a major concern. Thanks to the proliferation of fast-food restaurants, and a general lack of exercise, the number of obese Americans is sky rocketing. Being obese does not merely impact a person's self-esteem and confidence. Being obese also increases the risk for many health conditions and diseases, such as, retinal vascular disease, renal insufficiency, hypertension, stroke, coronary artery disease, Alzheimer's disease, certain cancers, such as prostate cancer, osteoarthritis, respiratory insufficiency, sleep apnea, congestive heart failure, hyperlipidemia, gall bladder disease, Type 2 Diabetes and Mellitus.

Current weight management systems rely on crash dieting and unsupervised medical treatments that ultimately prove to be unsatisfactory. What is needed is an effective, data driven physician-supervised, comprehensive medical treatment program that is aimed at reducing the incidence of obesity and obesity related illnesses.

### SUMMARY OF THE INVENTION

The present invention advantageously provides a flexible, virtually integrated weight management system and maintenance program that is fully scalable to the needs of a physician group, hospital, or hospital system. In an online environment, prospective patients are invited to register for the program, and, if approved, are presented with interactive sessions, where, under the supervision of an assigned physician or health coach, the patient receives medical advice and step-by-step medical guidance in order to achieve the patient's desired medical goals. Sessions are completed, results obtained, and interactive feedback is presented to the patient on a periodic basis. Depending upon the progress of the patient, sessions can be tailored to address the patient's improvement or lack thereof. When the patient has achieved his or her medical goals, the physician discontinues their care, the program concludes, and the patient is prompted to receive health supplements.

In one aspect of the invention, an online health management system is provided. The system includes a database, where the database stores a set of proprietary clinical protocols to be applied to one or more patients, a patient portal for receiving patient-related information from the one or more patients, a physician portal for allowing a physician to provide instructions to the one or more patients utilizing the clinical protocols, and an administrative entity for providing online interactive wellness sessions to the one or more patients and assigning physicians to patients, wherein the wellness sessions include the instructions to the one or more patients.

In another aspect, a computer implemented interactive health management method is provided. The method includes receiving, by an administrative entity, patient-related information from a patient, receiving, by the administrative entity, a selection by the patient of a patient program, the patient program comprising one or more online interactive wellness sessions, assigning to the patient, by the administrative entity, a coach to assist the patient in the patient program, and coordinating, by the administrative entity, the one or more online interactive wellness sessions between the patient and the coach.

In yet another aspect, a non-transitory computer readable storage medium is provided, where the storage medium includes instructions that, when executed by at least one processor of a computing system, causes the computing system to receive, at a server, patient-related information from a patient, receive, at the server, a selection by the patient of a patient program, the patient program comprising one or more online interactive wellness sessions, each interactive wellness session including a tutorial, assign, to the patient, a coach to assist the patient in the patient program, and coordinate the one or more online interactive wellness sessions between the patient and the coach.

### BRIEF DESCRIPTION OF THE DRAWINGS

A full understanding of the present invention and the features and benefits thereof will be obtained upon review of the following detailed description together with the accompanying drawings and simulation results, in which:

FIG. 1 is a diagram illustrating the interaction of the patient portal, the physician portal and the administrative portal in accordance with embodiments of the present invention;

FIG. 2 is a flowchart illustrating the steps taken by the patient portal, the physician portal and the administrative portal in accordance with embodiments of the present invention;

FIG. 3 is an exemplary patient screen providing medical advice and guidance to the user in accordance with embodiments of the present invention;

FIG. 4 is an alternate patient screen in accordance with embodiments of the present invention;

FIG. 5 is an exemplary patient screen providing a quiz to be completed by the patient in accordance with embodiments of the present invention;

FIG. 6 is an exemplary patient screen listing completed past sessions in accordance with embodiments of the present invention;

FIG. 7 is an exemplary patient screen illustrating progress made by the patient in accordance with embodiments of the present invention;

FIG. 8 is an exemplary physician screen listing summary information about a patient in accordance with embodiments of the present invention; and

FIG. 9 is an exemplary physician screen listing information about a patient including their start date, last session and alerts in accordance with embodiments of the present invention.

### DETAILED DESCRIPTION OF THE INVENTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

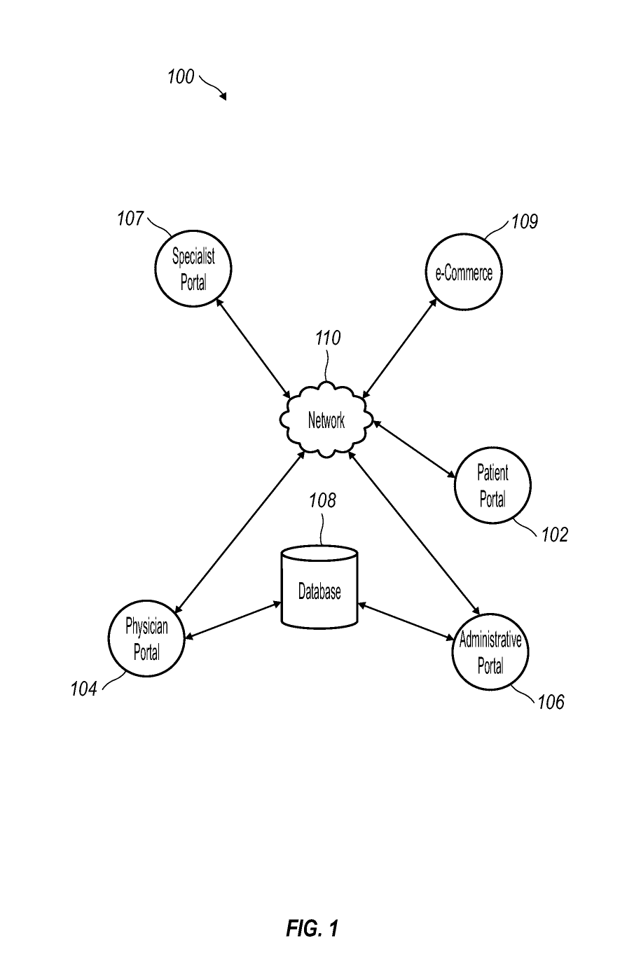

FIG. 1 illustrates a high level example of an environment 100 for implementing aspects in accordance with various embodiments of the present invention. A patient portal 102 is provided in order to allow one or more patients to register for the online health management program (also referred to, herein, as the “program” or “health management program”) of the present invention. Through patient portal 102, patients can apply for registration to the program, provide medical and health information, choose or be recommended a personal program, receive interactive medical advice from medical coaches or physicians in the form of online periodic sessions and be presented with the opportunity to purchase health-related products.

Physician portal 104 is provided to allow physicians or medical coaches to communicate with registered patients online. Physicians, via portal 104, can view lists of patients that have been assigned to them, provide interactive feedback to the patients, and view the progress of their assigned patients. The term “physician”, “coach” and “medical coach” are used interchangeably throughout this application and shall mean one having the requisite medical knowledge and skill to assist and provide competent medical advice to patients utilizing the online interactive health management system of the present invention.

Administrative portal 106 allows an administrative entity to control the interaction between patients and physicians in environment 100. Through administrative portal 106, patients, depending upon their medical needs, can be matched to an appropriate physician. Patients can be added or removed from a patient database, product orders from patients can be processed, and new patient registration and existing patient renewals can be coordinated by the administrative entity via the administrative portal 106. The administrative entity using administrative portal 106 also has access to a database 108. As will be discussed in greater detail below, database 108 can store a set of proprietary clinical protocols to be applied to one or more patients. Further, patient data, including their medical history, financial information, and answers to interactive medical-based quiz questions, can be stored in database 108.

Patient portal 102, physician portal 104 and administrative portal 106 can interact with each other via network 110. Network 110 can be the Internet, or any other suitable network that allows for wired or wireless data transmission. Patients can access patient portal 102 from their computer, phone or any electronic device capable of accessing network 110. Similarly physicians and administrator representatives can access physician portal 104 and administrative portal 106 respectively via network-enabled electronic devices. Thus, network 110 allows for online communication between all the portals in a seamless fashion.

Via administrative portal 106, an administrative representative of the administrative entity controls the interaction between registered patients and assigned physicians. Further, the administrative representative can provide the patient with access to an online store once the patient has completed the requisite sessions of their assigned program or at another pre-designated time. Environment 100 of the present invention uses a “triangular” approach whereby an administrative entity, via portal 106, registers patients, selects physicians to interact with registered patients, coordinates the interaction between patients and physicians, views all communication between patients and physicians, generates programs and program sessions tailored to the specific medical and health needs of each registered patient, and provides each patient with access to an online store where each patient may purchase health-related products.

A specialist portal 107 can also be included in environment 100. Specialist portal 107 can be accessed by one or more medical specialists, such as, for example, a cardiologist that could, if needed, provide medical advice beyond the advice that can be provided by the physician/coach. For example, if the assigned physician notices a particular anomaly with regard to the patient's progress, or the patient's response to one of the session quiz questions raises serious health concerns, the physician may enlist the assistance of a medical specialist with specific knowledge and expertise in a particular medical field. The physician, via physician portal 104, or an administrative representative, via administrative portal 106, may contact the specialist, via portal 107, over network 110.

As will be discussed in greater detail below, the patient may be granted access to an e-Commerce store 109. This might occur at various stages. For example, when the patient has selected a program, they may be given access to e-Commerce store 109 where they can purchase health-related items online. In other embodiments, when the patient has paid their registration fee, they are allowed to access certain features within the e-Commerce store 109.

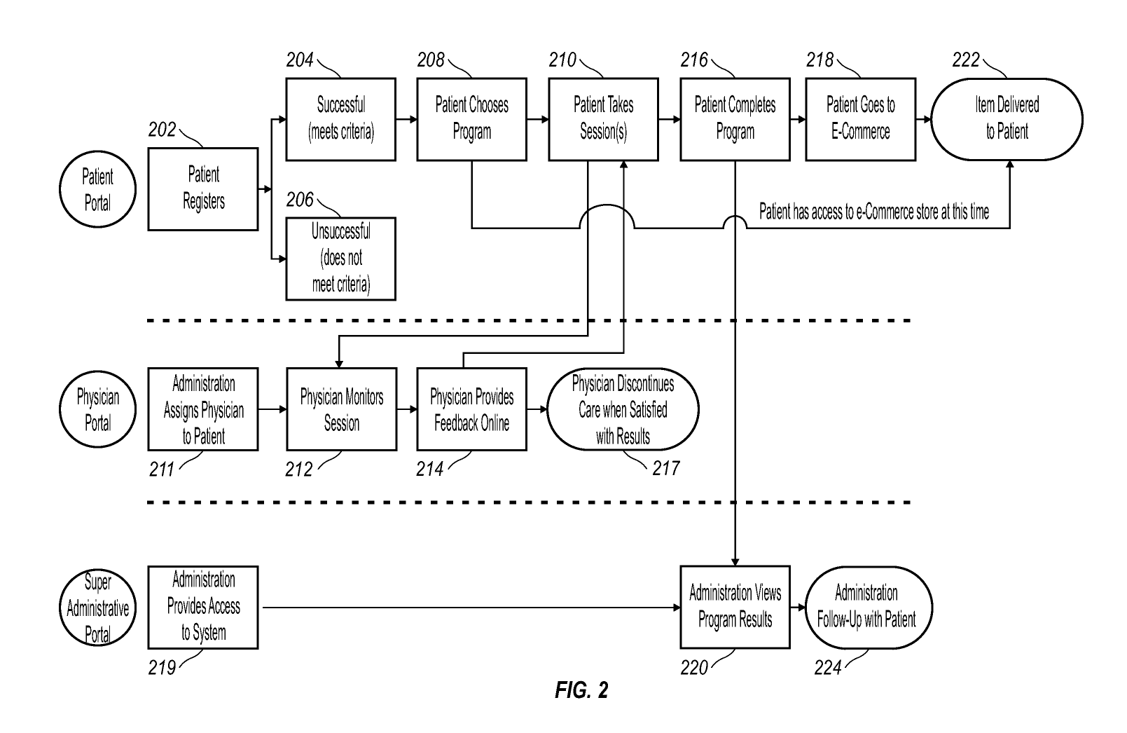

FIG. 2 illustrates flow diagrams for patient portal 102, physician portal 104 and administrative portal 106. A patient who wishes to access the program can, via the patient's electronic device that has access to network 110, access a web site that includes a patient registration page in order to register for the program, at step 202. Alternately, a prospective patient can call or email an employee of the health management program of the present invention, and a return email will be sent to the patient with a registration link. When arriving at the registration page, the patient may be asked to provide a passcode to enter the system. The passcode may be sent to the patient in the email that the patient receives upon inquiring about the health management program.

The patient receives an introductory description of the weight management program, and may be asked to provide some information about the patient's weight-loss history and medical history. In one embodiment, a patient weight-loss history questionnaire is provided. The patient's complete past and current medical history records are then reviewed. This review may reveal such health factors as the patient's alcohol consumption, lifestyle, food addiction, frequency of travel, business demands, family issues, and overall level of stress.

Upon filling out the registration form, which may involve the patient entering information about themselves, a determination is made as to whether the patient has met certain criteria and is thereby eligible for the health management system, at step 204, or has failed to meet certain criteria and is therefore not eligible for the program, at step 206. The information that the patient enters could include but is not limited to, physical characteristics, including age, weight, level of physical activity per week, desired health and medical goals, etc., and/or financial information which may impact the patient's ability to participate in the program, etc. The criteria used to determine whether a prospective patient is eligible for the program can be a variety of factors such as whether it is medically safe for the prospective patient to undergo a restricted caloric diet.

Once it has been determined that the patient has met the requisite criteria to register for and participate in the program, the patient then selects their desired program, at step 208. The selected program consists of one or more sessions, which are presented to the patient, at step 210. The sessions are presented to the patient in the form of an online tutorial, once they sign into the program. In another embodiment, the sessions can be “pushed out” to the client in the form of emails or text messages. In one embodiment, the patient is prohibited from accessing subsequent sessions until they have completed their current session. The sessions presented to the patient, which will be discussed in greater detail below, are interactive weight and/or health management and wellness sessions that deliver content and/or questions to the patient over a period of time, such as daily or weekly, or any other designated time period. The content can be provided to the patient in the form of an online interactive tutorial. The sessions are designed to encourage patients to lose weight or achieve their health-related goals. Patients that have multiple programs assigned to them can switch back-and-forth between programs at any time.

In an alternate embodiment, one or more session options are presented to the patient based on the information entered by the patient during the registration process. In this embodiment, depending upon the medical history of the patient, characteristics about the patient, and the patient's desired goals, one or more sessions can be presented to the patient and tailored to meet the patient's medical and dietary needs. For example, if a 45-year old client with a history of weight problems and family history of diabetes would like to join the program, this information is processed and a clinical protocol tailored to the patient is obtained from data base 108. The clinical protocol is tailored into a program session designed specifically for the patient. After a new patient has registered with the program, he or she is assigned a physician, at step 211. This can be accomplished by an administrative representative of the administrative entity reviewing the information provided by the new patients in order to select, from a listing of physicians participating in the program, those physicians that are suitable to provide care to the patient during the selected patient session. Further, the processor can determine, based on information provided by the patient and information in database 108 about the qualifications of each physician, which physician should be assigned to each registered patient. Thus, depending upon the patient's background, medical history, and health goals, a physician whose background, experience, and skills are tailored to match the patient and their medical needs, is selected to interact with the patient during the selected session or sessions. Once the physician is selected, the physician will be able to interact with the patient and monitor the patient session, at step 212.

The physician provides feedback to each patient that has been assigned to him/her, via step 214. Physician-patient feedback could be in the form of emails from the physician to the patient, or via an online HIPAA-compliant message board, informing the patient how they are progressing on their sessions. This can be done by the physician activating the “communicate” tab or accessing the message board once communication between the physician and patient has been established, and providing feedback and guidance as to the patient's progress. The communication between the physician and the patient can be in the form of an interactive patient assessment where suggestions can be made to assist the patient in making proper lifestyle choices, including, for example, adjusting the timing and quality of the patient's meals, and determining the adequacy of the patient's water consumption. Patients may be questioned about reasons for their decrease in weight loss including the patient's alcohol consumption, additional carbohydrate intake, poor timing of meals, and be provided with advice on how, what, and when to eat while traveling and how to handle cravings and moments of hunger.

The patient continues with the assigned sessions until the program is complete, at step 216, at which time the physician assigned to the patient discontinues their care if they are satisfied with the patient's results, at step 217. In one embodiment, if the program consists of multiple sessions, the patient may not proceed to the next session until they have completed the necessary requirements for their current session. The assigned physician can continue to provide care and advice to the patient if the physician feels necessary or if dissatisfied with the patient's results, even if the patient has completed their assigned program. An administrative representative is provided access to the program, at step 219, and once the patient program is complete, the administrative representative reviews the patient's program results, at step 220.

When the patient has completed their program, at step 216, they can then be provided access to other program features, including access to an e-commerce portal, at step 218. Via the e-commerce portal, the patient can, among other things, view frequently asked questions, review the program enrollment guide, participate in an online forum, and order items such as health-shakes, protein bars, or other health-related products from the e-Commerce store 109, which are then delivered to the patient, at step 222. In an alternate embodiment, after completion of their program, a “refresher program” can be offered to the patient. This might be a program, perhaps with a limited number of sessions, designed to review many of the medical issues raised and discussed during the patient's previous program.

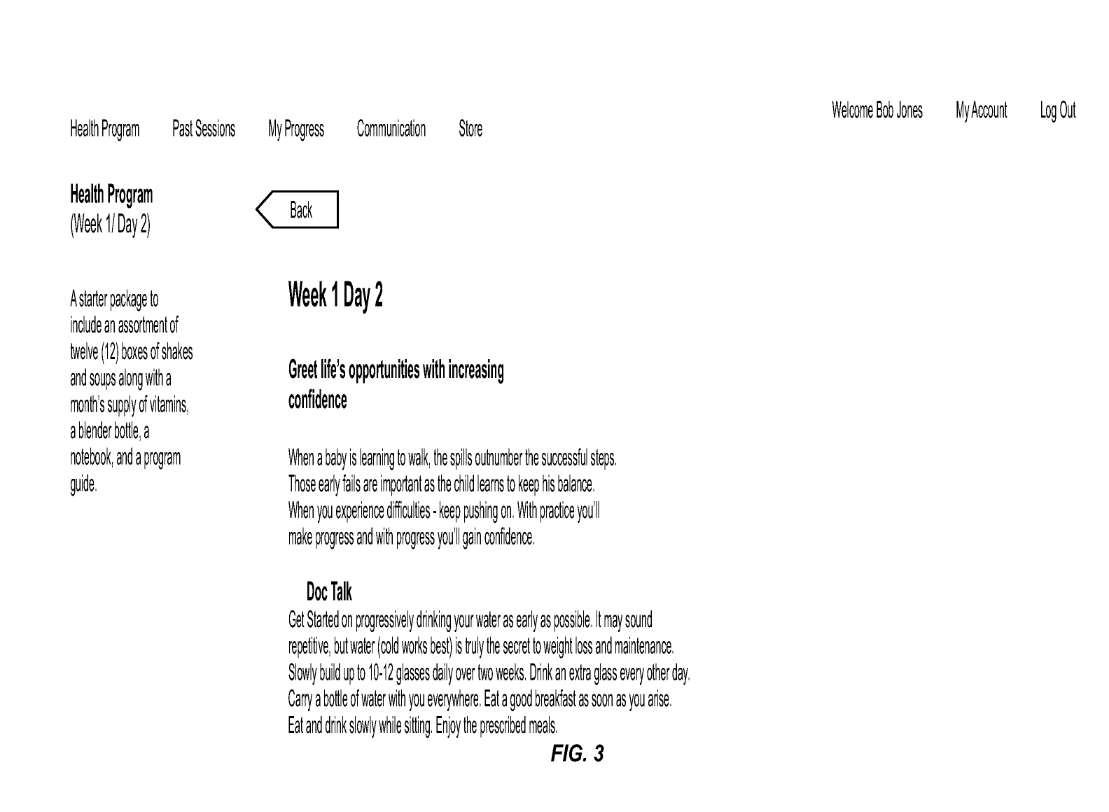

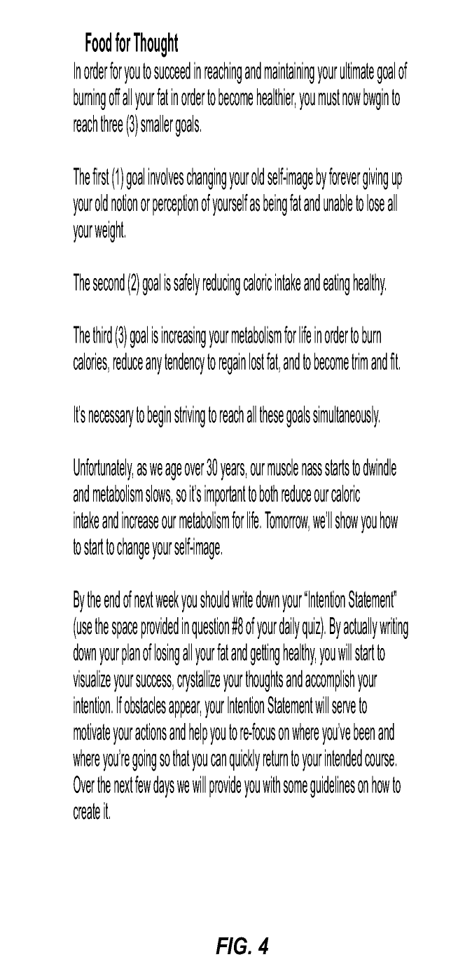

FIG. 3 and FIG. 4 illustrate an exemplary embodiment of a computer screen that would be presented to a patient once that patient has registered with the program. In the example depicted in FIGS. 3 and 4, the patient has started a session and is now in the second day of the online program (indicated by “Week 1/Day 2”). An exemplary screen may present an inspirational statement such as “Greet life's opportunities with increasing confidence”, followed by motivational guidance. FIG. 3 also provides the patient with the ability to receive more information about the Health Program they have registered for, view Past Sessions, view their overall progress (“My Progress”) in the program, communicate with the assigned physician or with an administrative representative, and access the e-Commerce store 109 to purchase products, if they are eligible to do so. FIG. 4 lists a series of goals chosen for the patient. In this example, the patient is prompted to give up their old habits by reducing their caloric intake, eating healthy, and increasing their metabolism. The screens of FIGS. 3 and 4 are exemplary only, and the invention is not limited to a precise series of instructions or guidelines.

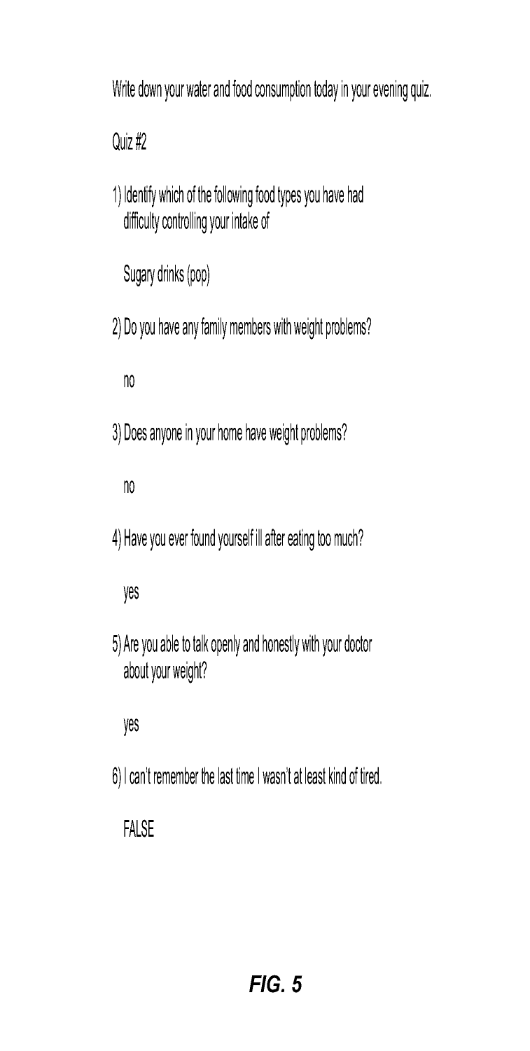

FIG. 5 is an exemplary patient screen providing a quiz to be completed by the patient as part of their program sessions. In order for each patient to proceed to the next program sessions, they may be asked to answer certain questions provided to them in the form of a quiz or tutorial. In one embodiment, each program includes pre-designed sessions. However, in other embodiments, the answers provided by the patient may determine the questions formulated in the next session's quiz, thus altering the subsequent sessions for a particular program. In still another embodiment, certain answers by the patient during a session may cause the patient to be reassigned to another program. At the end of each day, or other designated period of time, the assigned physician reviews the patient's answers to the quiz questions, and can provide feedback online, via email or a telephone call. While the next sessions' quiz questions need not be influenced by the patient's answers, in some embodiments, certain answers by the patient may trigger different questions in one or the ensuing session's quiz.

Each patient's assigned program consists of one or more sessions. Each session can be specifically tailored to the patient's needs, depending upon the information the patient provided during the registration phase. Each session can include, for example, inspirational or motivational messages, step-by-step instructions for the patient to complete for the day, suggested food/caloric intake, and a series of questions in the form of an online quiz. In one embodiment, the patient is required to complete each question or a predetermined number of questions in order to complete the session and be allowed to move on to the next session.

As discussed above, environment 100 includes database 108, which stores clinical protocols which can be accessed by the physician and/or an administrative representative in order design an appropriate program for each registered patient. The clinical protocols can include a series of medical guidelines, quiz questions, motivational quotes, exercise programs, diet information, etc. The protocols in database 108 can be used to tailor a specific program for a registered patient, depending upon the patient's overall level of fitness, health, lifestyle, needs, interests, and physical capabilities. In another embodiment, database 108 contains suggested vitamin and nutrient intake dosages that may be included as recommendations in a program session. The invention is not limited to any particular vitamin or nutritional supplement, and may vary according to each patient. Further, the invention is not limited to the type of program session or the type of medical and health-related information provided to the patient in each session.

In other embodiments, the physician-supervised coaching program of the present invention includes, among other things, mindfulness lessons and therapy, yoga and de-stressing techniques, how to manage cravings, the timing of meals, travel and work related tips, and choices of snacks.

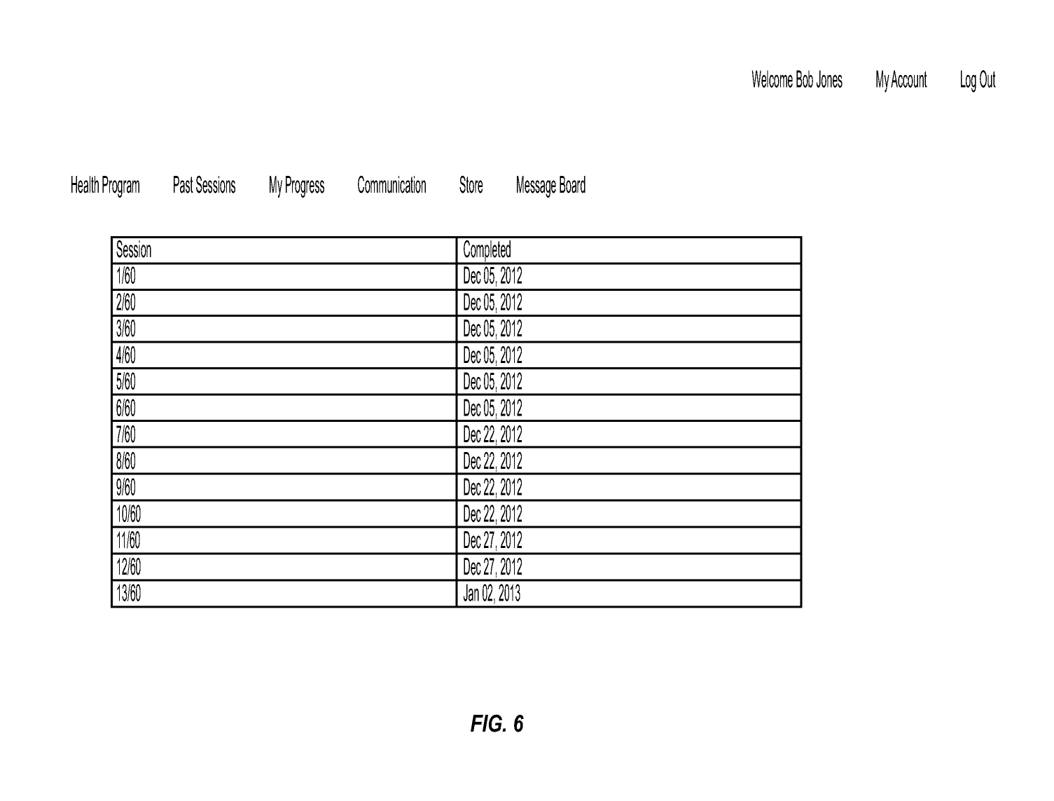

If the patient wishes to obtain information about one or more of their past sessions, they can click on the icon shown in FIG. 3 (“Past Sessions”) and may be presented with a screen such as the one shown in FIG. 6. Here, the patient can selected a previous session, for example, their 8^{th} session out of 60, which took place on Dec. 22, 2012, and review the information from that session. This advantageously allows the patient to go back to review previous quiz questions to see if they have been complying with the answers that they provided, or to review previous advice provided by the assigned physician. In this fashion, the patient has the ability to self-monitor their progress.

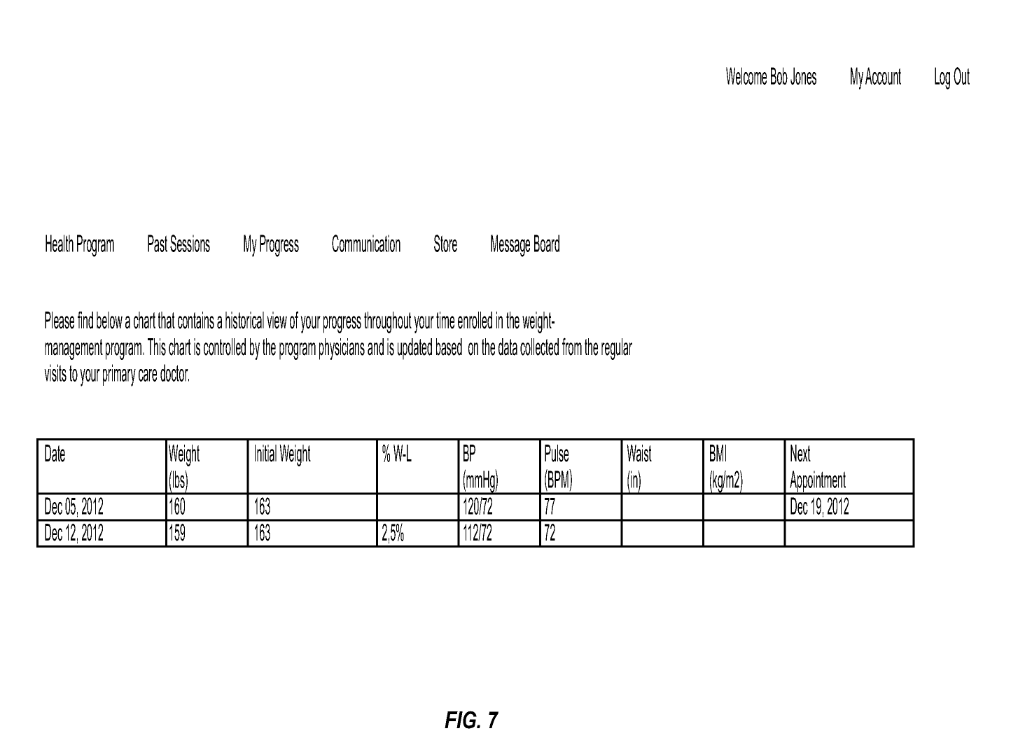

The patient may more accurately monitor their progress by clicking on the “My Progress” icon on the screen shown in FIG. 3. FIG. 7 illustrates an exemplary screen indicating the patient's progress in the program. In this exemplary view, the patient is able to view their progress from session to session, in this case week to week, and can gauge their progress by viewing such parameters as changes in weight, blood pressure, pulse, waist size, and BMI (body mass index). The screen depicted in FIG. 7 is exemplary only and the screen can include other features that will enable to patient to determine the effectiveness of the program sessions. The assigned physician may also view the data shown on this screen. Based on the patient's progress or lack thereof, the physician assigned to the patient can vary their feedback to the patient. For example, the assigned physician can suggest more cardiovascular exercise, a different diet, more rest or sleep, mediation, etc., if the physician feels the patient is not progressing with the program at a desired level.

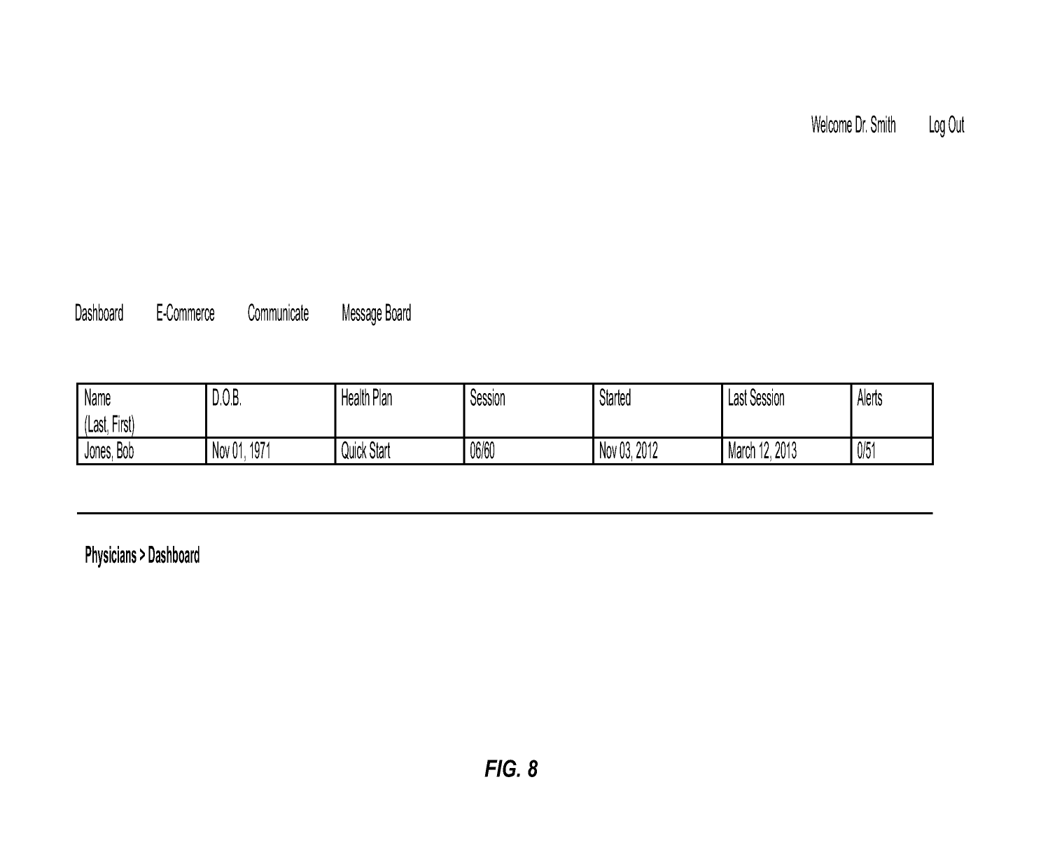

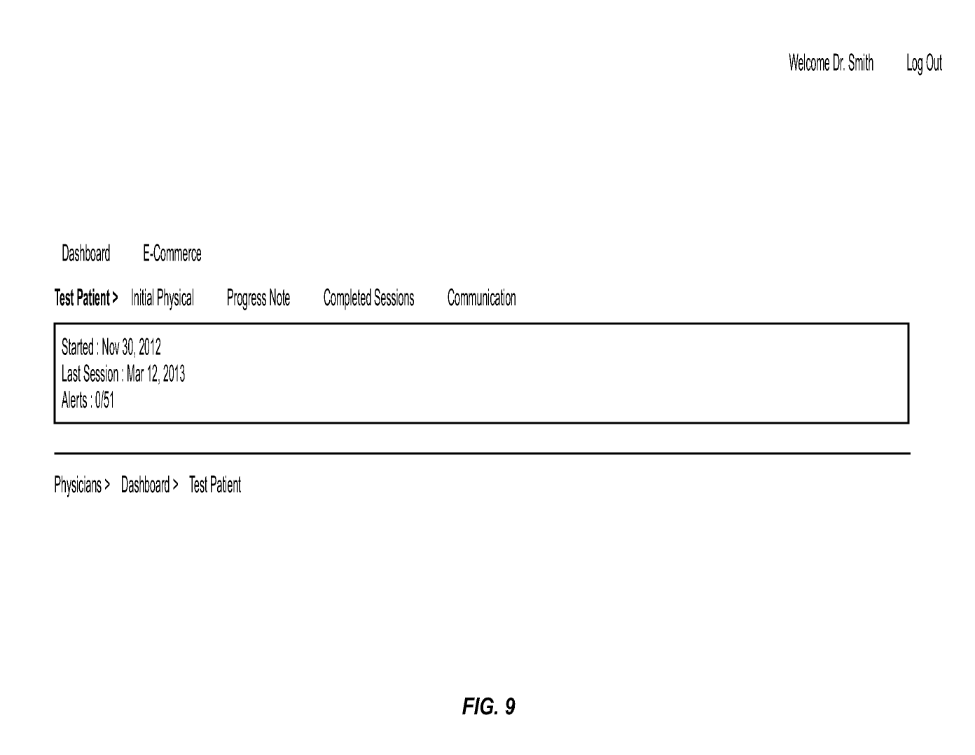

FIG. 8 depicts an exemplary physician screen listing summary information about each of the patients assigned to the physician. For simplicity, only one patient, Bob Jones, is listed. In this view, the assigned physician obtains a summary of each patient and associated information about that patient such as their date of birth, the type of program they have registered for, which session they are currently on, the patient's start date in the program, the date of their last completed session, and any alerts that might have been generated in the patient's previous session due to the patient's responses to quiz questions. For example, if the patient is asked, in a quiz question, about the amount of physical activity that patient had engaged in during the previous week, or their caloric intake, and the patient's reply is less than the required level of physical activity or caloric intake, an alert may be generated. The alert may prompt the physician, an administrative assistant, or a specialist, to take some type of action, including contacting the patient, altering the medical advice provided to the patient, etc. Alerts can be programmed to be activated at different stages and for different events, such as when the patient response falls outside of an expected response. FIG. 9 depicts an alternative view of a patient's progress. In this exemplary embodiment, Dr. Smith can view the data the patient has started the program, the date of their last session, and any alerts that may have been generated for a specific patient. Other information such as the date and results of the patient's initial physical, progress notes, a summary of completed sessions and prior communications with the patient, may be viewed.

Programs may include automatic reminders and indicators in order to enable the patient to follow his or her designated program. For example, the patient may receive daily text messages on their mobile device asking if they went for their morning walk or ate their prescribed 9 AM meal. The patient may receive an email asking if they ate dessert the previous day and if so, reminding the patient to eliminate one dessert from today's meals.

In other embodiments, the patient is provided with a device that measures caloric expenditure, for example, in the form of a bracelet or other device attached to the body of the patient. The patient can synchronize or connect the device to their personal computer or mobile electronic device and information regarding the patient's caloric intake or expenditure can be uploaded to system 100 via network 110 and patient portal 102. This information can be processed, stored and used to monitor the patient's progress with regard to caloric intake and expenditure. If necessary, program sessions can be designed or re-designed using the information uploaded from the device.

In other embodiments, the patient may be given assigned an avatar that represents the patient and embodies the patient's physical characteristics as they progress in the program. For example, when a patient is registered to the program they are presented with a personal avatar representing the patient's initial physical appearance. The patient can then access this avatar online and be presented with their visual progress through their avatar. For example, as the patient progresses through the sessions, the patient is awarded with points, and their avatar can gain desired features. For example, the avatar might be able to gain a muscular appearance, lose weight, have more energy to perform certain tasks, etc. This illustrates the patient's positive progress. On the other hand, should the patient fail to achieve certain baseline goals and loses points, the appearance of their avatar might change negatively, or certain activities that the avatar had been granted, may be taken away.

The present invention allows the physician to receive new data from the patient on a periodic basis, i.e., daily. This provides a real-time “snapshot” of the patient's health. The patient receives a visual representation of their progress, thus motivating them to sign on to each session, receive the medical advice and assignments that are presented in the sessions and to view their progress. The present invention provides a streamlined, automated physician-patient interaction including live “coaching” with behavior assessment and modification, as well as follow up consultations.

The present invention may be implemented using hardware or software in association with hardware. Furthermore, the present invention may take the form of a computer program product that includes program modules accessible from computer-usable or computer-readable medium storing program code for use by or in connection with one or more computers, processors, or instruction execution systems. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium (though propagation mediums in and of themselves as signal carriers are not included in the definition of physical computer-readable medium). Examples of a physical computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. Both processors and program code for implementing each as aspect of the present invention can be centralized or distributed (or a combination thereof) as known to those skilled in the art.

A data processing system suitable for storing a computer program product of the present invention and for executing the program code of the computer program product will include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters can also be coupled to the system to enable the data processing system to become coupled to other data processing systems or remote printers or storage devices through intervening private or public networks. Modems, cable modem and Ethernet cards are just a few of the currently available types of network adapters. Such systems can be centralized or distributed, e.g., in peer-to-peer and client/server configurations. In some embodiments, the data processing system is implemented using one or both of FPGAs and ASICs.

1. An interactive health management system comprising:
a processor;
a database, the database configured to cause the processor to store a set of proprietary clinical protocols to be applied to one or more patients;
a patient portal configured to cause the processor to receive patient-related information from the one or more patients, the patient-related information including a patient's caloric expenditure obtained from a device measuring caloric expenditure;
a physician portal configured to cause the processor to allow a physician to provide instructions to the one or more patients utilizing the clinical protocols; and
an administrative entity configured to cause the processor to provide interactive wellness sessions to the one or more patients in the form of at least one of an email or a text message, wherein the wellness sessions include the instructions to the one or more patients, the administrative entity configured to:
generate an alert if the patient's caloric expenditure is less than a required level;
initiate an action in response to the alert;
formulate the wellness sessions based at least in part upon the patient's caloric expenditure;
upon registration of a patient with the online health management system, assign to the patient a personal avatar representing the patient's initial physical appearance;
perform at least one of awarding points or removing points to the patient, where the awarding and removing of points to the patient indicates the patient's progress through the online interactive wellness sessions; and
change an appearance of the personal avatar depending upon the awarding or removing of points to the patient.

2. The interactive health management system of claim 1, wherein the administrative entity assigns the physician to the one or more patients.

3. The interactive health management system of claim 2, wherein the assigning of the physician to the one or patients is based at least on the patient-related information received at the patient portal.

4. The interactive online health management system of claim 1, wherein the online wellness session includes a tutorial, the tutorial including one or more questions presented to the patient.

5. The interactive online health management system of claim 4, wherein the patient completes a current wellness session before being provided access to one or more subsequent wellness sessions.

6. The interactive online health management system of claim 5, wherein the patient is provided access to an online store upon completion of a predetermined number of the online wellness sessions.

7. The interactive online health management system of claim 5, wherein the one or more subsequent wellness sessions are based at least on answers, provided by the patient, to the one or more questions presented during the tutorial.

8. A computer implemented interactive health management method comprising:
under the control of one or more computer systems configured with executable instructions,
receiving, by an administrative entity, patient-related information from a patient, the patient-related information including a patient's caloric expenditure obtained from a device measuring caloric expenditure;
receiving, by the administrative entity, a selection by the patient of a patient program, the patient program comprising one or more interactive wellness sessions;
assigning to the patient, by the administrative entity, a coach to assist the patient in the patient program;
coordinating, by the administrative entity, the one or more interactive wellness sessions between the patient and the coach, the interactive wellness sessions being provided to the patient in the form of at least one of an email or a text message;
generating, by the administrative entity, an alert if the patient's caloric expenditure is less than a required level;
initiating, by the administrative entity, an action in response to the alert;
formulating, by the administrative entity, the wellness sessions based at least in part upon the patient's caloric expenditure;
upon registration of a patient with the online health management system, assigning to the patient, by the administrative entity, a personal avatar representing the patient's initial physical appearance;
performing, by the administrative entity, at least one of awarding points or removing points to the patient, where the awarding and removing of points to the patient indicates the patient's progress through the online interactive wellness sessions; and
changing, by the administrative entity, an appearance of the personal avatar depending upon the awarding or removing of points to the patient.

9. The method of claim 8, further comprising presenting, to the patient, an interface for the patient to purchase health-related items at an online store.

10. The method of claim 8, wherein the interface is presented to the patient upon the selection by the patient of the patient program.

11. The method of claim 8, wherein assigning a coach to assist the patient in the patient program is based at least on the patient-related information received from the patient.

12. The method of claim 8, wherein the one or more online wellness sessions includes a tutorial, the tutorial including one or more questions presented to the patient.

13. The method of claim 12, further comprising providing the patient with access to one or more subsequent wellness sessions upon completion of a current wellness session.

14. The method of claim 13, wherein the one or more subsequent wellness sessions are based at least on answers, provided by the patient, to the one or more questions presented during the tutorial.

15. A non-transitory computer readable storage medium including instructions that, when executed by at least one processor of a computing system, causes the computing system to:
receive, at a server, patient-related information from a patient the patient-related information including a patient's caloric expenditure obtained from a device measuring caloric expenditure;
receive, at the server, a selection by the patient of a patient program, the patient program comprising one or more interactive wellness sessions, each interactive wellness session including a tutorial;
assign, to the patient, a coach to assist the patient in the patient program;
coordinate the one or more online interactive wellness sessions between the patient and the coach, the interactive wellness sessions being provided to the patient in the form of at least one of an email or a text message;
generate an alert if the patient's caloric expenditure is less than a required level;
initiate an action in response to the alert;
formulate the wellness sessions based at least in part upon the patient's caloric expenditure;
upon registration of a patient with the online health management system, assign to the patient a personal avatar representing the patient's initial physical appearance;
perform at least one of awarding points or removing points to the patient, where the awarding and removing of points to the patient indicates the patient's progress through the online interactive wellness sessions; and
change an appearance of the personal avatar depending upon the awarding or removing of points to the patient.

16. The non-transitory computer readable storage medium of claim 15, wherein the instructions when executed further cause the computer system to present to the patient, an interface for the patient to purchase health-related items.

17. The non-transitory computer readable storage medium of claim 16, wherein the interface is presented to the patient upon the selection, by the patient, of the patient program.

18. The non-transitory computer readable storage medium of claim 15, wherein the computing system assigns the coach to assist the patient in the patient program based at least on the patient-related information received from the patient.

19. The non-transitory computer readable storage medium of claim 15, wherein the tutorial includes one or more questions presented to the patient.

20. The non-transitory computer readable storage medium of claim 19, wherein the instructions when executed further cause the computer system to provide the patient with access to one or more subsequent wellness sessions upon completion of a current wellness session.

21-23. (canceled)

24. The online health management system of claim 1, wherein the administrative entity initiates automated reminders to assure that the one or more patients are complying with the instructions of the wellness sessions.

25. (canceled)

26. (canceled)

27. The interactive health management system of claim 1, wherein the alert is at least one of contacting the patient or altering medical advice provided to the patient.

28. The interactive health management system of claim 1, wherein the administrative entity is further configured to generate different alerts for different events.

29. The interactive health management system of claim 2, further comprising a specialist portal configured to be accessible by a specialist, the specialist able to provide medical advice beyond advice that can be provided by the physician.
